(19) United States
(12) Patent Application Publication
(10) Pub. No.: US 2026/0311272 A1
(43) Pub. Date: Oct. 8, 2026

(54) Secure Digital Agreement System with Biometric, AI-Guided Consent, and Tokenized Storage

(71) Applicants: Telly Lopez-Fu, Burbank, CA (US); Farida Lam, Burbank, CA (US)

(72) Inventors: Telly Lopez-Fu, Burbank, CA (US); Farida Lam, Burbank, CA (US)

(21) Appl. No.: 19/169,792

(22) Filed: Apr. 3, 2025

(51) Int. Cl. G06Q 50/18

(52) U.S. Cl. CPC G06Q 50/18

(57) ABSTRACT

A system and method for generating, verifying, and securely storing digitally executed agreements with multi-factor consent. The invention utilizes biometric authentication, AI-guided walkthroughs, depth mapping, and haptic signature capture to ensure that the signing party is a real, consenting human. Verbal and non-verbal indicators are analyzed for confirmation. The system records and synchronizes the user's video, audio, and signature metadata into a finalized agreement that is encrypted and stored. The system optionally issues a unique token identifier for future access, which can be anchored to a blockchain for tamper-proof verification. The invention is applicable across sensitive domains including entertainment, healthcare, finance, real estate, employment, and personal liability.

### II. FIELD OF THE INVENTION

The present invention relates to electronic consent systems and digital contract execution. More particularly, it concerns systems using multi-factor human verification, artificial intelligence, and privacy-focused storage to validate legally significant agreements.

### III. BACKGROUND OF THE INVENTION

Traditional digital signature platforms primarily rely on simple click-to-sign or typed-name mechanisms. These methods are often insufficient in scenarios requiring irrefutable proof of identity, intent, and comprehension-especially in industries dealing with legal risk, consent, or high-value transactions. With advances in generative AI and synthetic media, the need for human verification during agreement execution is critical. Existing platforms lack integrated solutions for verifying a human signer, assessing comprehension, and maintaining user privacy during long-term document retention.

### IV. SUMMARY OF THE INVENTION

The disclosed invention provides a secure and comprehensive method for capturing and storing consent-based agreements. The system uses biometric authentication (e.g., Face ID or passcode), device-based depth mapping, and fallback identity checks to verify the signer. A large language model (LLM) walks the user through the agreement step-by-step, monitoring for verbal and visual indicators of comprehension. The entire process is recorded. The user then provides a haptic signature, captured with pressure, stroke speed, and timestamp data synchronized to the video. The finalized agreement is compiled into a PDF with references to the video, encrypted, and stored with an optional blockchain-linked token. Access is strictly controlled and subject to consent, with third-party access requiring multi-party approval unless waived. The system is applicable across a range of sectors requiring secure consent documentation.

### V. BRIEF DESCRIPTION OF THE DRAWINGS

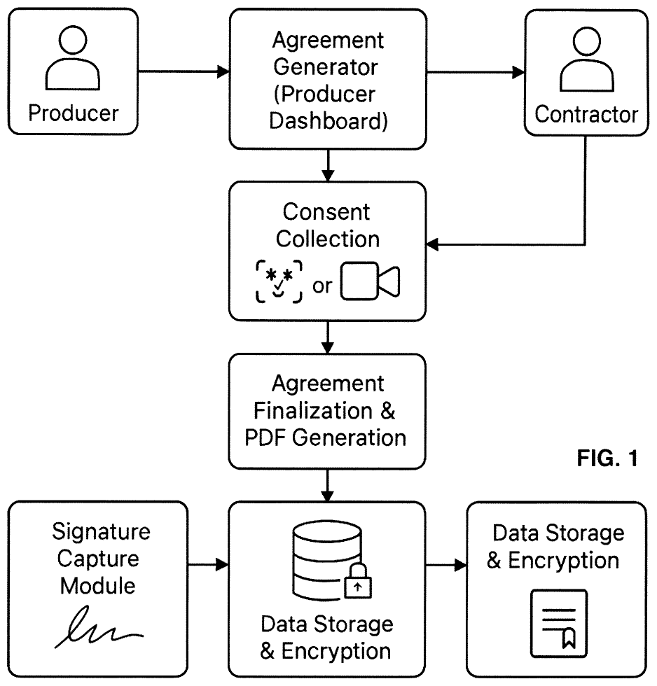

### FIG. 1—System Architecture Overview

FIG. 1 is a block diagram depicting the high-level system architecture of the secure digital agreement platform. The architecture consists of a Producer interface, a Contractor portal, and a backend server environment. The Producer interface enables the generation of agreement terms and dispatch of tokenized links. The Contractor portal comprises components responsible for identity verification, consent walkthrough, video recording, signature capture, and consent validation. The backend includes a tokenization engine, PDF generator, metadata logger, and encrypted data storage module. The system further includes an optional blockchain anchoring service and an access control module for regulating third-party verification requests. Each component interacts through secure API channels, and all user inputs and outputs are logged and traceable for compliance auditing.

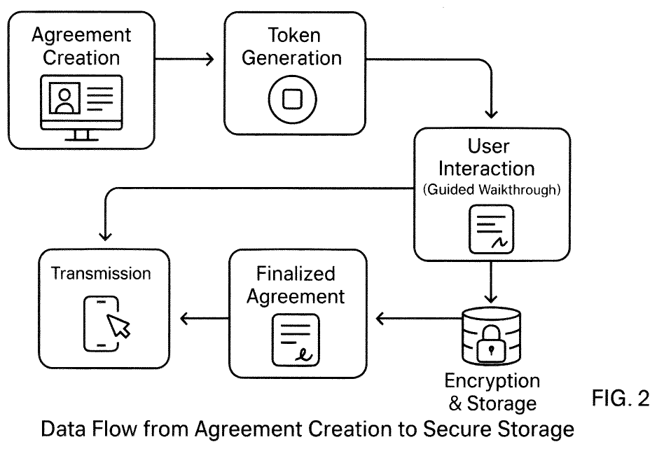

### FIG. 2—Data Flow From Agreement Creation to Secure Storage

FIG. 2 is a flow diagram illustrating the data lifecycle from the initial creation of a digital agreement by a Producer to the secure storage of the finalized, consent-verified agreement package. The system begins by receiving input from the Producer via a web-based interface, wherein agreement terms are specified. Upon submission, the system generates a tokenized agreement link and transmits it to the Contractor through a digital communication channel such as email or SMS.

When the Contractor accesses the link, the system initiates a multi-factor authentication process, including biometric verification (e.g., Face ID, fingerprint, passcode entry) and optional fallback identity verification techniques if native sensors are unavailable. Following successful authentication, the system launches an AI-guided walkthrough of the agreement, during which a large language model (LLM) reads and explains each clause. The Contractor's verbal responses and visual cues (e.g., nodding or head shaking) are monitored and recorded for consent confirmation, with contradictions triggering automated clarification prompts.

Upon completion of the walkthrough, the Contractor is prompted to provide a haptic signature via a touchscreen interface. The signature is captured alongside biometric stroke data (e.g., pressure, speed) and time-synchronized to the video and audio recordings. The system then compiles the agreement terms, the recorded haptic signature, and a reference to the video walkthrough into a finalized PDF document.

All associated data-including the PDF, video, audio, and metadata-are encrypted and uploaded to secure storage. A unique token identifier is generated to represent the agreement package, with optional anchoring to a blockchain ledger for external verification. This token may be used by authorized parties to reference or verify the existence and integrity of the agreement, subject to access controls and user-defined privacy policies.

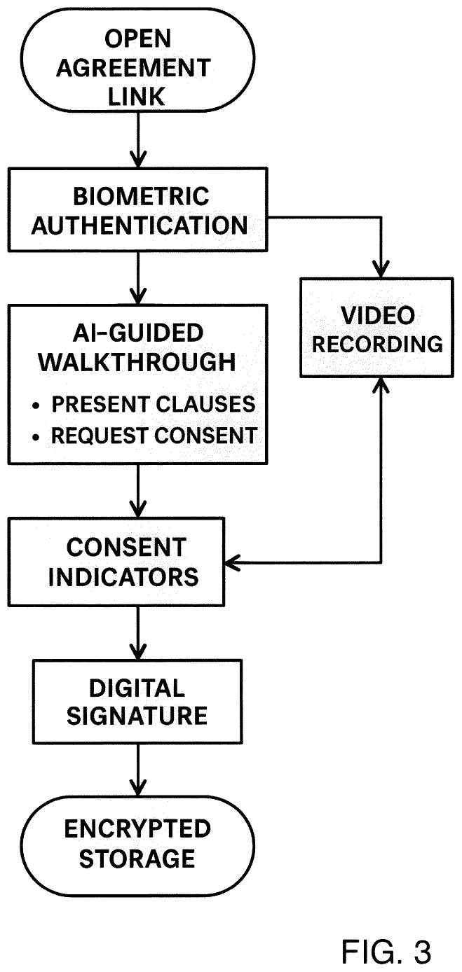

### FIG. 3—Contractor Consent Interface Walkthrough Flow

FIG. 3 illustrates a stepwise flowchart of the Contractor's interaction with the system from the moment they open the agreement link to final submission. Upon link access, the system initiates device-level biometric authentication. Once identity is verified, the Contractor is guided through the agreement by an AI-driven walkthrough engine. This engine presents clauses one at a time, provides verbal and/or textual explanations, and prompts the user for affirmative consent through verbal, visual, or touch-based signals. The system captures and evaluates these inputs using a consent indicator module. If any contradiction or ambiguity is detected, the system requests clarification before proceeding. The walkthrough continues until all clauses are addressed, after which the system prompts the user for a digital signature and compiles all captured data into a complete record.

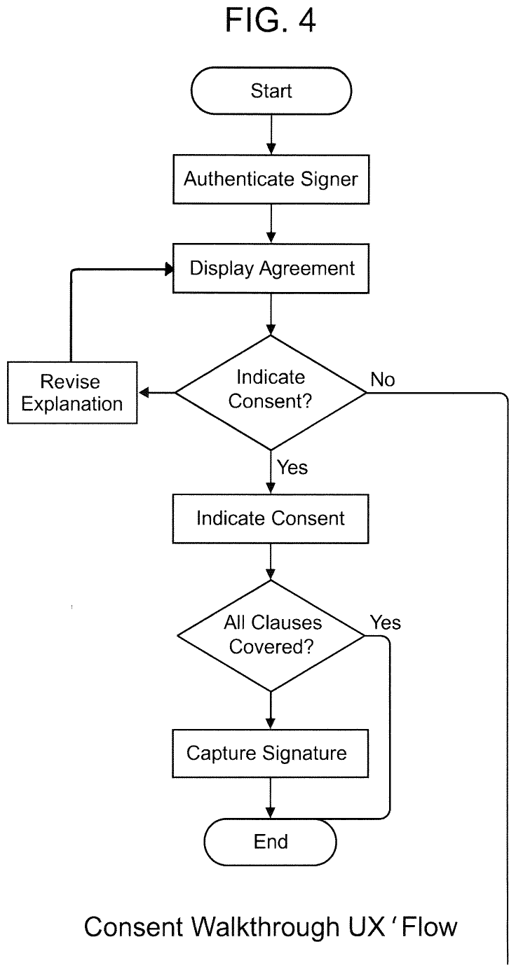

### FIG. 4—Biometric and Haptic Verification Synchronization Diagram

FIG. 4 is a timing diagram demonstrating the synchronization between biometric signature input and the recorded video/audio stream. The signature capture interface collects real-time data points, including pressure, stroke direction, velocity, and sequence. These are time-stamped at the moment of entry and cross-referenced against the corresponding frame and audio segment in the consent recording. This synchronization ensures the signature was made by the same individual who participated in the consent walkthrough, thereby enhancing identity integrity and legal enforceability. The diagram illustrates parallel data streams from the video/audio recorder and the haptic input module, converging in a timestamp correlation engine that outputs a unified verification layer within the agreement package.

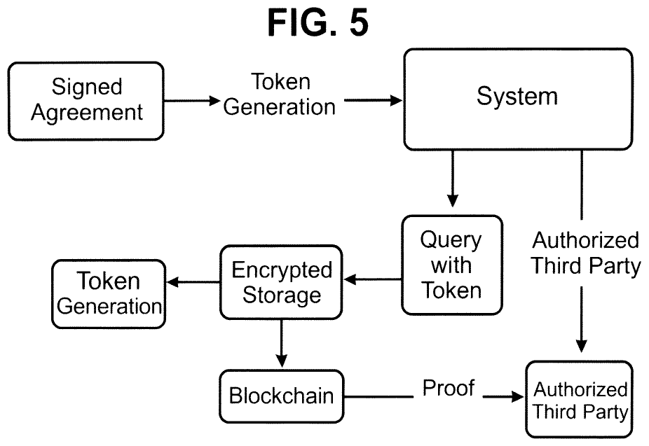

### FIG. 5—Tokenized Access and Third-Party Verification Flow

FIG. 5 presents a process diagram showing how third-party entities (such as clients, regulators, or content platforms) can request and receive verification of an executed agreement using a tokenized access protocol. Upon receiving a token from a Producer or Contractor, a third party submits a verification request through a secure interface. The system validates the token and determines access rights based on the original agreement's privacy settings. If disclosure is allowed, the system either confirms existence and authenticity or, if full data access is requested, initiates a multi-party consent workflow. In cases where both signatory parties have waived notification requirements, access may proceed immediately. The system logs all access attempts and generates an audit trail for compliance. Blockchain anchoring may optionally provide public verification of the token's validity and timestamp.

### VII. DETAILED DESCRIPTION OF THE INVENTION

### 1. Agreement Generator

The agreement generator is a user-facing interface accessible by the Producer. It enables the Producer to input agreement terms such as parties involved, compensation, terms of service, consent details, and customized clauses. The generator produces a formatted agreement and assigns a unique token. The agreement is linked to a secure, shareable URL delivered to the Contractor.

### 2. Biometric and Depth Mapping Verification

Upon accessing the agreement, the Contractor is prompted by the system to authenticate their identity using biometric verification, such as Face ID, fingerprint, or passcode entry. The system checks for native device support for depth sensing (e.g., LiDAR or TrueDepth). If unavailable, it uses light modulation patterns via the screen and front-facing camera to approximate a depth map. This ensures that a real, 3D human face is interacting with the device.

### 3. AI-Guided Walkthrough and Consent Monitoring

A large language model (LLM) provides a narrated, clause-by-clause walkthrough of the agreement. The Contractor is prompted to give verbal affirmations and may be asked to provide initials or signatures after each section. The system records the session and uses an AI-powered consent indicator module to analyze nods, head shakes, and verbal responses. If contradictory inputs are detected (e.g., saying “no” while nodding yes), the AI flags the discrepancy and prompts the user to clarify.

### 4. Video and Audio Recording

The system captures video and audio of the Contractor throughout the walkthrough process. This serves as a record of real-time comprehension and consent. The video is timestamped and linked to specific sections of the agreement. Video quality is optimized based on device capabilities and stored in encrypted form.

### 5. Haptic Signature Capture and Synchronization

After the walkthrough, the Contractor is prompted to sign using their touchscreen. The haptic signature module records not only the drawn signature but also pressure sensitivity, stroke velocity, and drawing pattern. These data points are synchronized to the video using a timestamp engine to validate that the person who signed is the same individual appearing in the recording.

### 6. Pdf Compilation and Metadata Logging

The system compiles the agreement, signature, and a link (or QR code) to the video into a finalized PDF. It logs all metadata, including time, IP address, device ID, MAC address, and authentication outcomes. This document becomes a verifiable artifact that can be accessed by authorized parties.

### 7. Encrypted Storage and Tokenization

Finalized agreement packages-including text, video, audio, and signature data-are encrypted using industry-standard protocols (e.g., AES-256) and stored securely. A unique token identifier is generated for the package. In some embodiments, the token is anchored to a blockchain ledger, creating a tamper-proof reference to the agreement's existence and integrity.

### 8. Third-Party Access and Privacy Controls

The token may be shared with third parties to verify the existence and validity of a consented agreement. If access to the full contents is requested, the system provides a limited-access interface and notifies the Producer and Contractor. Disclosure only occurs if both parties consent or if such notification is waived in the original agreement. The system is compliant with GDPR and CCPA standards.

I claim:

1. A computer-implemented method for generating, verifying, and recording a consent-based agreement between a Producer and a Contractor, the method comprising:
receiving, by a system, agreement terms input by a Producer;
generating, by the system, a digital agreement comprising the received terms;
creating and transmitting, by the system, a unique tokenized agreement link to a Contractor;
initiating, by the system, a biometric authentication process on a Contractor's device, wherein authentication is performed using Face ID, passcode entry, or other device-native biometric authentication;
capturing, by the system, a depth map of the Contractor's face using device-native sensors or fallback software-based light modulation techniques;
initiating an AI-guided walkthrough of the agreement using a large language model (LLM), wherein the Contractor is prompted to provide verbal and visual consent for each clause, and wherein the system detects and flags contradictory consent indicators for clarification;
recording, by the system, a video and audio capture of the Contractor's interaction during the AI-guided walkthrough;
capturing, by the system, a haptic signature input from the Contractor via a touchscreen interface, wherein the signature includes pressure and stroke data, and is synchronized with the recorded video via timestamp metadata;
generating, by the system, a finalized agreement document comprising the agreement terms, the haptic signature, and a reference to the recorded consent video;
encrypting and storing, by the system, the finalized agreement and associated metadata in secure storage;
issuing, by the system, a unique token identifier referencing the agreement, wherein the token is optionally anchored to a blockchain for external verification.

2. A system for managing consent-based digital agreements between a Producer and a Contractor, the system comprising:
an agreement generator configured to receive agreement terms from a Producer and generate a digital agreement;
a tokenization module configured to assign a unique identifier to the digital agreement;
a Contractor portal configured to:
receive the tokenized agreement;
trigger biometric authentication using device-native capabilities;
initiate a depth mapping process using device-native sensors or fallback light pattern analysis;
present an AI-guided walkthrough of the agreement;
detect contradictory consent indicators based on verbal and nonverbal cues;
record video and audio consent of the Contractor;
capture a haptic signature with biometric data and timestamp synchronization;
a synchronization engine configured to correlate signature data and video metadata;
a PDF generation engine configured to compile the agreement, signature, and reference to the recorded video;
an encrypted storage module configured to store the finalized agreement and associated consent metadata;
a public or private access verification system configured to:
issue a unique token identifier;
optionally anchor the identifier to a blockchain;
restrict third-party access without consent from the Contractor and Producer, unless such notification is waived in the agreement.

3. The method of claim 1, wherein the biometric authentication comprises Face ID, fingerprint, passcode entry, or WebAuthn authentication.

4. The method of claim 1, wherein if biometric authentication fails, the Contractor is prompted to upload a government-issued ID and a photo of themselves holding the ID, and wherein the system verifies the images for identity confirmation.

5. The system of claim 2, wherein the Contractor portal further comprises a fallback identity verification module configured to guide the user through capturing and uploading government ID and face-matching photos.

6. The method of claim 1, wherein the depth map is generated by screen-based light modulation analyzed through the front-facing camera when device-native sensors are unavailable.

7. The method of claim 1, wherein the AI-guided walkthrough includes real-time monitoring of verbal indicators and head gestures to detect affirmative or contradictory responses.

8. The method of claim 1, wherein upon detection of contradictory consent indicators, the system prompts the Contractor for verbal clarification before proceeding.

9. The system of claim 2, wherein the Contractor portal further includes a consent indicator module configured to detect visual or verbal inconsistencies and log corrective prompts.

10. The method of claim 1, wherein the haptic signature comprises time-synchronized stroke data, pressure sensitivity, and drawing velocity.

11. The system of claim 2, wherein the synchronization engine is further configured to cross-reference haptic signature data with the recorded video timestamp to verify temporal alignment.

12. The method of claim 1, wherein all stored agreement data complies with GDPR and CCPA standards for personal data protection and informed consent.

13. The method of claim 1, wherein third-party access to stored agreement data requires explicit consent from both the Contractor and Producer, unless waived in the agreement.

14. The system of claim 2, wherein the access verification system is configured to present third-party requestors with a limited-access interface requiring predefined data requests and notifying all signatory parties before disclosure, unless such notification is waived in the agreement.

15. The method of claim 1, wherein the AI-guided walkthrough is recorded in the Contractor's preferred language and includes a synchronized text transcript in both the Contractor's and Producer's languages.

16. The system of claim 2, wherein the agreement generator is further configured to insert initial fields after each clause, requiring digital confirmation before progressing to the next section.

17. The system of claim 2, wherein the token identifier is anchored to a distributed blockchain ledger for independent, timestamped verification.

18. The system of claim 2, wherein a spoof-prevention module issues screen-based multi-touch CAPTCHA challenges to detect automated or synthetic actors.

19. The method of claim 1, wherein the agreement is used in any context requiring sensitive consent or legally significant transactions, including but not limited to medical procedures, financial disclosures, real estate or title transfers, non-disclosure agreements, entertainment work, employment contracts, or personal liability waivers.
